(19) United States
(12) Patent Application Publication
(10) Pub. No.: US 2012/0046018 A1
(43) Pub. Date: Feb. 23, 2012

(54) Entertainment Venue Search Systems and Methods

(76) Inventor: Gregory William Bunting, Dallas, TX (US)

(21) Appl. No.: 13/112,966

(22) Filed: May 20, 2011

Related U.S. Application Data
(60) Provisional application No. 61/376,059, filed on Aug. 23, 2010.

(51) Int. Cl. H04W 4/00

(52) U.S. Cl. 455/414.2

(57) ABSTRACT

Systems and methods for identifying and/or searching for entertainment venues are provided. According to an illustrative embodiment, a method for identifying an entertainment venue includes receiving a location of a user, receiving a user-selected date and time, and receiving a user-selected set of entertainment venue attributes. The method also includes comparing the location, the user-selected date and time, and the user-selected set of entertainment venue attributes with entertainment venue attributes for a plurality of entertainment venues to determine a set of customized entertainment venues. The method also includes presenting the set of customized entertainment venues to the user.

### CROSS-REFERENCE TO RELATED APPLICATIONS

This application claims the benefit, of U.S. Provisional Application No. 61/376,059 filed Aug. 23, 2010, which is hereby incorporated by reference.

### TECHNICAL FIELD

The illustrative embodiments relate generally to searching systems, and more particularly, to entertainment venue search systems and methods.

### BACKGROUND

When choosing an entertainment venue, such as a bar, restaurant, sporting event, social event, etc., potential patrons may be faced with an overwhelming number of choices. Indeed, finding entertainment venues that cater to one's needs, interests, preferences, budget, location, etc. may be an arduous task, especially given the sheer number of entertainment venues that are often available. While computer and Internet technology may be utilized to facilitate the identification of entertainment venues, current systems fail to provide users with a convenient and/or centralized way to find entertainment venues that cater to their particular interests or needs.

### SUMMARY

According to an illustrative embodiment, a method for identifying an entertainment venue includes receiving a location of a user, receiving a user-selected date and time, and receiving a user-selected set of entertainment venue attributes. The method also includes comparing the location, the user-selected date and time, and the user-selected set of entertainment venue attributes with entertainment venue attributes for a plurality of entertainment venues to determine a set of customized entertainment venues. The method also includes presenting the set of customized entertainment venues to the user.

According to another illustrative embodiment, a method for identifying an entertainment venue includes receiving a set of entertainment venue attributes from a plurality of entertainment venues to form an entertainment venue profile for each of the plurality of entertainment venues. The method also includes receiving a location of a user, receiving a user-selected date and time, and receiving a user-selected set of entertainment venue attributes. The method also includes comparing the location, the user-selected date and time, and the user-selected set of entertainment venue attributes with the entertainment venue profiles to determine a of customized entertainment venues. The method also includes presenting the set of customized entertainment venues to the user.

According to another illustrative embodiment, an entertainment venue manager includes a user interface to receive a location of a user, a user-selected date and time, and a user-selected set of entertainment venue attributes. The entertainment venue manager also includes an entertainment venue determination engine to compare the location, the user-selected date and time, and the user selected set of entertainment venue attributes with entertainment venue attributes for a plurality of entertainment venues to determine a set of customized entertainment venues. The entertainment venue manager also includes an entertainment venue presentation module to present the set of customized entertainment venues to the user.

### BRIEF DESCRIPTION OF THE DRAWINGS

FIG. 1 is a schematic, pictorial representation. of an entertainment venue identification system according to an illustrative embodiment;

FIG. 2 is a schematic, block diagram of an entertainment venue identification system according to an illustrative embodiment;

FIG. 3 is a schematic, pictorial representation of a prompt in which a user may input his or her location according to an illustrative embodiment;

FIG. 4 is a schematic, pictorial representation of a prompt in which a user may input a date and/or time according to an illustrative embodiment;

FIG. 5 is a schematic, pictorial representation of a prompt in which a user may input a user-selected set of entertainment venue attributes according to an illustrative embodiment;

FIG. 6 is a flowchart of a process for identifying an entertainment venue according to an illustrative embodiment;

FIG. 7 is a flowchart of a process for comparing the location, the user-selected date and time, and user-selected set of entertainment venue attributes with entertainment venue attributes for a plurality of entertainment venues to determine a set of customized entertainment venues according to an illustrative embodiment;

FIG. 8 is a flowchart of a process for identifying entertainment venues according to another illustrative embodiment; and

FIG. 9 is a schematic, block diagram of a data processing system in which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description on may omit certain information known to those skilled in the art. The following detailed description is, therefore, not to be taken in limiting sense, and the scope of the illustrative embodiments are defined only by the appended claims.

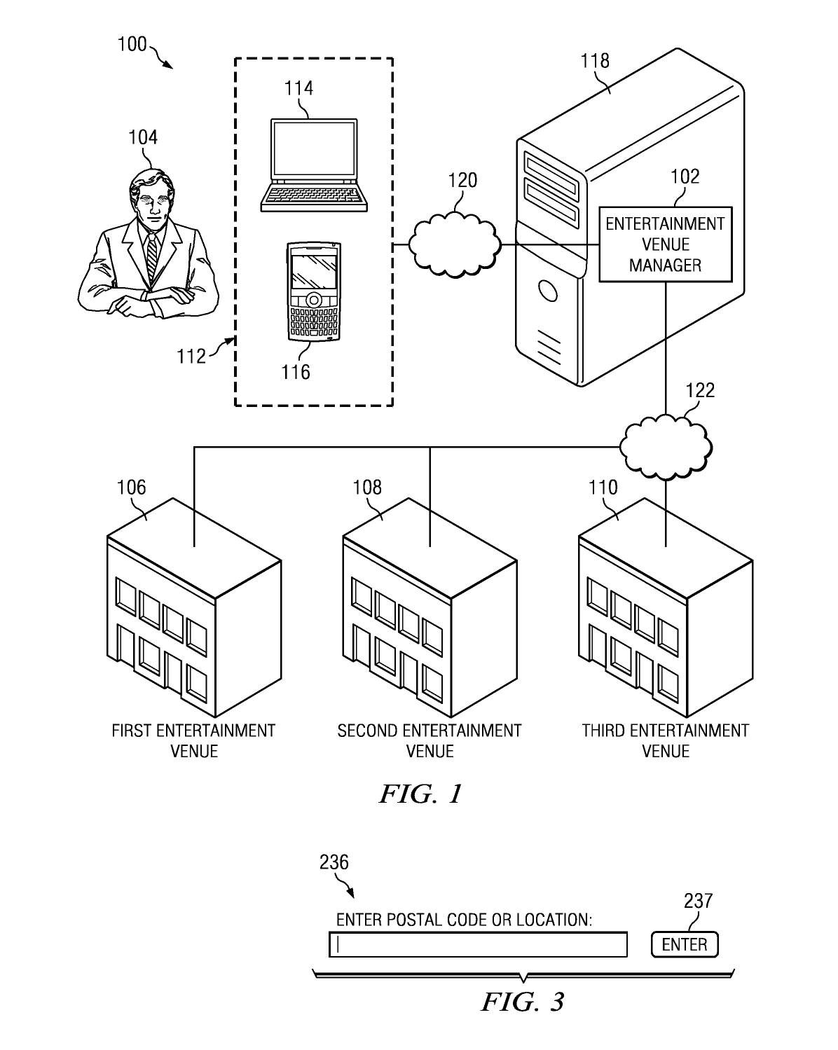

Referring to FIG. 1, an illustrative embodiment of an entertainment venue identification system 100 includes an entertainment venue manager 102 that allows a user 104 to search for or identify one or more entertainment venues (e.g., a first entertainment venue 106, a second entertainment venue 108, and/or a third entertainment venue 110) that have one or more attributes desired, or otherwise selected, by the use 104. Unless otherwise indicated, as used herein, “or” does not require mutual exclusivity. Although FIG. 1 illustrates the entertainment venue identification system 100 to include three entertainment venues 106, 108, and 110, any number of entertainment venues may be searchable or identifiable by the entertainment venue manager 102. The entertainment venues 106, 108, 110 may include any place or event having an entertainment, social, educational, religious, spiritual, or enrichment quality or aspect, including, but not limited to, a bar, club, restaurant, sporting event, lounge, coffee shop, meeting, casino, sporting venue (e.g., a golf course, a bowling alley, etc.), festival, opening, exhibition, campus, church, social club/group, convention, seminar, hotel, motel, hostel, fund raiser, charity event, theatre, private country club, open country club, alumni event, etc.

The user 104 may interact with the entertainment venue manager 102 using one or more communication devices 112, including mobile communication devices. The communication devices 112 may include any device capable of communicating with another device. For example, the communication devices 112 may include a computer (e.g., a laptop, netbook, tablet computer, desktop computer, or minicomputer), a cellular phone (e.g., a smart phone), a personal digital assistant, a digital reader, a kiosk, a portable gaming device, a web browser device, media player, etc. In the non-limiting example of FIG. 1, the communication devices 112 used by the user 104 to communicate with the entertainment venue manager 102 include a laptop 114 and a cellular phone 116. In the embodiment in which a mobile communication device is used to interact with the entertainment venue manager 102, the mobile communication device may be in communication with the entertainment venue manager 102 via a base station or tower.

Entertainment venue attributes of the entertainment venues 106, 108, 110 may be stored by the entertainment venue manager 102 while, in one embodiment, the entertainment venue attributes for each of the entertainment venues 106, 108, 110 may be provided by the entertainment venues 106, 108, 110 themselves, the entertainment venue attributes may be received or stored from any source, manual, automated, or otherwise. As explained in more detail below, the entertainment venue manager 102 may store entertainment venue profiles for any of the entertainment venues 106, 108, 110 that are searchable or identifiable by the entertainment venue manager 102. Also, it will be appreciated that, in some embodiments, no communication between the entertainment venue manager 102 and the entertainment venues 106, 108, 110 may be necessary for the implementation of the entertainment venue manager 102, despite the inclusion in FIG. 1 of a data communication medium 122.

In one embodiment, the user 104 may use one of the communication devices 112 to input criteria to the entertainment venue manager 102 so that the entertainment venue manager 102 may search for and identify one or more entertainment venues 106, 108, 110 based on the criteria inputted by the user 104. The criteria selectable by the user 104, and usable by the entertainment venue manager 102 to search for and identify one or more entertainment venues 106, 108, 110, may include the location of the user 104, a date and/or time (e.g., a date or time that the user 104 desires to patronize an entertainment venue), and/or a user-selected set of entertainment venue attributes.

used herein, including in the claims, the term “set” encompasses a quantity of one or more. The user-selected set of entertainment venue attributes may include attributes or offers (including special offers) of entertainment venues that the user 104 desires. For example, the user-selected set of entertainment venue attributes may include venue themes, food options, drinks options, special interests, or sports options, or a combination thereof. Additional details regarding the types of user-selectable entertainment venue attributes are provided below.

With respect to the use of the location of the user 104 so search for and identify one or more entertainment venues 106, 108, 110, the entertainment venue manager 102 may prompt the user 104, using of the communication devices 112, to input data (e.g., zip code, postal code, address, landmark, neighborhood, etc.) indicative of the user's location so that the entertainment venue manager 102 may locate the user 104 using this data. In vet another embodiment, instead of or in conjunction with receiving location data from the user 104, the entertainment venue manager 102 may locate the user 104 using other techniques or processes. For example, the entertainment venue manager 102 may locate the user 104 using an internet protocol, or IP, address of one of the communication devices 112 being used by the user 104. In an example In which the user 104 is communicating with the entertainment venue manager 102 using a mobile communication device, such as the cellular phone 116, the entertainment venue manager 102 may locate the user 104 by locating the mobile communication device 116 using a global positioning system (GPS), triangulation, or any other technique or process for locating a mobile communication device. Indeed, any global, regional, or local locating systems may be used by the entertainment venue manager 102 to locate the user 104, or any communication devices 112 associated therewith.

The entertainment venue manager 102 may compare the criteria associated with the user 204 (e.g., a location. of the user 104, a date and/or time selected. by the user 104, a user-selected set of entertainment venue attributes, etc., or any combination thereof) with entertainment venue attributes for a plurality of entertainment venues 106, 108, 110 to determine a set of customized entertainment venues. The set of customized entertainment venues may include one or more entertainment venues identified by the entertainment venue manager 102 to meet the needs or desires of the user 104 based on any combination of criteria (e.g., user location, user-selected date and time, user-selected set of entertainment venue attributes, etc.) associated with the user 104. The customized. entertainment venues may then be presented to the user 104 on one of the communication devices 112.

The techniques or processes by which the entertainment venue manager 102 may determine the set of customized entertainment venues for the user 104 are numerous, and will be explained in further detail below. By way of non-limiting example, the entertainment venue manager 102 may detect the location of the cellular phone 116 using GPS to determine the location of the user 104. In this example, the user 104 may also enter a date and time at which he or she wishes to patronize an entertainment venue, such as a bar. The user 104 may use the cellular phone 116 to input that he or she desires a salsa bar that has margarita specials during the date and time selected by the user 104. Based on these criteria, the entertainment venue manager 102 may search a database of entertainment venue attributes of the entertainment venues 106, 108, 110 and determine a set of customized. entertainment venues matching or partially matching user's criteria; these customized entertainment venues may then be presented to the user. The set of customized entertainment venues may be presented to the user 104 on the graphical user interface of the mobile communication device 116, and may be sorted in any manner, such as by relevance, a number of matched keywords, the distance to the user 104, alphabetical order, the importance of any particular criteria selected by the user 104, etc. Also, details about each of the customized entertainment venues may be presented to the user 104, including an address, mapped location, hours of operation, contact information, website, etc. In addition, any matching attributes of the customized entertainment venues may be displayed to the user 104.

To provide another illustrative example, the user 104 may send his or her ZIP code to the entertainment venue manager 102 using a website interface on the laptop 114, and the entertainment venue manager 102 may determine the location of the user 104 based on the inputted ZIP code. The user 104 may also select a date and time at which he or she wishes to patronize an entertainment venue, and select that he or she is interested in a Mexican restaurant that will be playing a particular football game that is of interest to the user 104. Again, the entertainment venue manager 102 may compare these criteria to the attributes of the entertainment venues 106, 108, 110 to find any entertainment venues that match these criteria, and thereby determine the set of customized entertainment venues for the user 104.

In one embodiment, the entertainment venue manager 102 may be implemented on one or more servers 118. In this embodiment, the user 104 may access the entertainment venue manager 102 over the Internet, including by accessing a website of the communication devices 112 that interfaces the use 104 with the entertainment venue manager 102 in another embodiment, the entertainment venue manager 102, or a portion thereof, may be deployed and loaded on one of the communication devices 112 as an application. In one example, the application may be designed for a mobile communication device, such as an iPhone application, a Blackberry application, an Android® application, or any application executable a mobile communication device operating system associated therewith. In the example in which the entertainment venue manager 102 is deployable as an application on one of the communication devices 112, the functionality of entertainment venue manager 102, as described in the illustrative embodiments, they be distributed across two or more devices, such as one of the communication devices 112 and the server 118.

The techniques, technologies, or media by which the components of the entertainment venue identification system 100 intercommunicate are numerous. For example, the entertainment venue identification system 100, or any portion thereof, may be part of a personal area network (PAN), a local area. network (LAN), a campus area network (CAN), a metropolitan area network (MAP), or any other network type. Also, communication between any two of the elements in the entertainment venue identification system 100 may be direct or indirect. Data communication medium 120 between the communication devices 112 and the server 118 and data communication medium 122 between the server 118 and the entertainment venues 106, 108, 110 may be any medium through which data can communicated for example, the data communication media 120, 122 may be wired or wireless data connections, and may utilize a virtual private network (VPN), multi-protocol label switching (MPLS), the Internet, or any other data communication media.

The data communication medium between the server 118 and any base stations may be of the same or similar type as any of the non-limiting examples provided for the data communication media 120, 122. Wireless communication between the mobile communication device 116 and a base station may utilize any wireless standard for communicating data, such as CDMA (e.g., cdmaOne or CDMA2000), GSM, 3G, 4G, Edge, an over-the-air network, Bluetooth, etc.

In one example, the entertainment venue identification system 100 may utilize the Internet, with any combination of the data communication media 120, 122 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 1 is intended as an example, and not as an architectural limitation for the different illustrative embodiments.

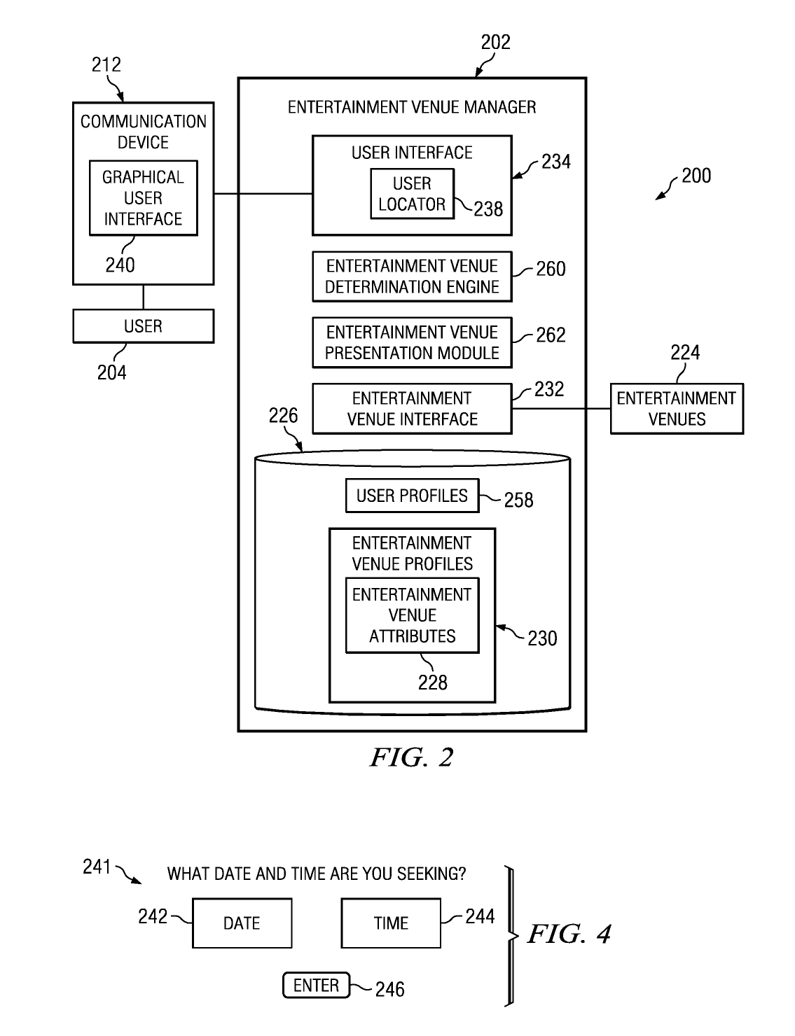

Referring to FIGS. 2 through 5, an illustrative embodiment of the entertainment venue identification system 200 is shown, including the entertainment venue manager 202 having elements used to implement the search and identification of entertainment venues 224 for the user 204. Elements of FIGS. 2 through 5 that are analogous to elements in FIG. 1 have been shown indexing the reference numerals by 100.

In one embodiment, the entertainment venue manager 202 may include a database 226, which may be internal or external to the entertainment venue manager 202, which includes the entertainment venue attributes 228 of the entertainment venues The database 226 may include entertainment venue attributes 228 for any number of entertainment venues 224 over any geographic region (e.g., citywide, countywide, statewide, nationwide, worldwide, etc.).

The entertainment venue attributes 228 may include any data about each of the entertainment venues 224, such as the entertainment venue name, location, hours of operation, popularity (e.g., popularity according to social networks or other Internet-gathered data), a description of the goods or services offered by the entertainment venue, the venue theme, food offered by the entertainment venue, drinks offered by lee entertainment venue, any special interests catered to by the venue, sports or sporting events offered by the entertainment venue, food or drink specials or discounts, etc. The entertainment venue attributes 228 may be searchable by the entertainment venue manager 202 so that suitable entertainment venues may be identified for the user 204, as described in the illustrative embodiments.

While the entertainment venue attributes 228 may be gathered from any source, in one embodiment the database 226 stores an entertainment venue profile for each of the entertainment venues 224. In example of this embodiment, the entertainment venue manager 202 may include an entertainment venue interface 232 that, among other things, may receive the entertainment venue attributes 228 inputted by the entertainment venues 224 to form the respective entertainment venue profiles 230 for each of the entertainment venues 224. By way of example to show how one of the entertainment venue profiles 230 may be generated and stored, one of the entertainment venues 224 may input (including manually) one or more entertainment venue attributes 228 of their entertainment venue. The entertainment venue interface 232 may receive the one or more entertainment venue attributes 228 from the entertainment venue. After receiving these entertainment venue attributes 228, the entertainment venue manager 202 may generate an entertainment venue profile 230 containing the entertainment venue attributes received from the entertainment venue. The entertainment venue profile 230 may be stored in the database 226. Other parameters that may be inputted by any of the entertainment venues 224 and stored in their respective entertainment venue profile 230 include keywords, hours of operation, venue name, links, venue contact information, venue staff, location, good and/or services, products, events, venue attributes, promotions, etc. Any number of entertainment venue profiles 230 may be generated and stored by the entertainment venue manager 202 for any number of entertainment venues 224. In one non-limiting example, the entertainment venues 224 may be required to pay or subscribe to the entertainment venue manager 202 to have an account or entertainment venue profile 230; however, in other embodiments, this may not be required.

In creating the entertainment venue profiles 230 for each of the entertainment venues 224, the entertainment venue manager 202 may allow or require each of the entertainment venues 224 to have an account with the entertainment venue manager 202. In this embodiment, the entertainment venues 224 may be allowed to log on and change (e.g., create, add, modify, delete, etc.) their entertainment venue profile 230 at any time and at their discretion, thus giving them an administrative privilege. Thus, the entertainment venues 224 may be allowed to dynamically change their entertainment venue profile 230 data at any time, such as updating any menu specials, daily specials, drink specials, extra hours, early closings, repair notices, etc. In addition, the entertainment venues 224 may be allowed to post and remove specials (e.g., drink specials) for finite periods of time (e.g., one hour, two hours, one day, etc.) by posting the special and then logging on a certain time later to remove the special in other embodiments, the inclusion of the entertainment venue attributes 228 for any particular entertainment venue 224 may not be dependent on an account being opened by the entertainment venue 224.

In one embodiment, the entertainment venue manager 202 may include a user interface 234 that interfaces with the user 204 by, inter alia, receiving criteria by which to identify entertainment venues 224 suitable for the user 204. For example, the user interface 234 may receive input from the user 204, via the communication device 212, indicating the location of the user 204, a date and/or time, and/or a user-selected set of entertainment venue attributes.

The location of the user 204 may be determined by the entertainment venue manager 202 in a variety of ways. In one embodiment, the location of the user 204 may be inputted by the user 204 using the communication device 212, and this location may be received by the user interface 234 of the entertainment venue manager 202. Referring to FIG. 3, the user interface 234 may initiate a prompt 236 on the graphical user interface 240 of the communication device 212. The user 204 may enter data indicative of his or her location in the prompt. 236, and then submit this data to the user interface 234 by, e.g., clicking on an enter button 237. Non-limiting examples of the type of location-associated data that may be entered into the prompt 236 include a ZIP code, postal code, address, neighborhood, landmark, or any other data associated with a desired or current. location of the user 204. The entertainment venue manager 202 may then determine the location of the user 204 based on the data entered in the prompt 236. In another embodiment, the entertainment venue manager 202 may directly use the data entered in the prompt 236 to match the user 204 with entertainment venues 224, such as by extracting keywords from the data entered in the prompt 236 and identifying matches between these keywords and the entertainment venue attributes 228 stored within the database 224.

In one embodiment, the user interface 234 includes a user locator 238 that may locate geographical position of the user 204 by detecting the location of the communication device 212. For example, the user locator 238 may locate the communication device 212, and by association, the user 204, using an Internet protocol address, or IP address, of the communication device 212. In another example, such as when the communication device 212 is a mobile communication device (e.g., cellular phone, portable computer, etc.), the user locator 238 may use a global positioning system (GPS), triangulation, or any other process or technique for determining the location of a mobile communication device.

The user interface 234 may also receive a user-selected date and time, which may be a date and time at which the user 204 desires to patronize an entertainment venue 224. The user-selected date and time may also be a date or time range. Referring to FIG. 4, the user interface 234 may initiate a prompt 241 on the graphical user interface 240 of the communication device 212 that allows the user 204 to enter the user-selected date and time. The prompt 241 may allow the user 204 to select a date button 242 that allows the user 204 to manually enter a date, or to initiate a calendar (e.g., pop-up calendar) that allows the user 204 to select a date. A time may be inputted by the user 204 in a similar manner, but by using a time button 240. Indeed, the prompt 241 may allow the user 204 to input a user-selected date and time in any manner. In another embodiment, the prompt 241 may include a button, such as a “right now” button, that allows the user 204 to conveniently select, the present date and time as the user-selected date and time at which the user 204 desires to patronize an entertainment venue. In another embodiment, the user-selected date and time may default to the present date and time, as detected by the entertainment venue manager 202 or a device or program associated with the entertainment venue manager 202; this detected user-selected date and time may then be used in subsequent searches. Once the user 204 has selected the user-selected date and time, the user 204 may send this data so the entertainment venue manager 202 by, e.g., clicking an enter button 245.

The user interface 234 may also receive a user-selected set of entertainment venue attributes, which may be entertainment venue attributes that the user 204 desires, or otherwise selects, in an entertainment venue. The user-selected set of entertainment venue attributes may include a variety of different types of entertainment venue attributes, such as a venue theme, a food option, a drink option, a special interest, a sports option, etc. A venue theme may be a theme or “type” that describes the entertainment venue, such as ballroom dancing, cantina, country-western, dance club, DJ music, gay, exotic dancing, hip-hop, jazz, karaoke, latin, lounge, live country music, live dance music, live hip-hop music, live jazz music, live rock music, live swing music, night club, English pub, Irish pub, restaurant, salsa, sports, festival, visual art, gambling, coffee shop, etc. A food option may be a type of food, food special, or other food-related attribute desired by the user 204. The food option may include, for example, a type of food for which the user 204 desires a special offer or a food special offering or recognition. Non-limiting examples of a food option include American, Asian, Asian fusion, barbecue, bar menu, brunch, buffet, Chinese, desserts, eclectic, English, French, German, gourmet, Greek, hamburger, Italian, Japanese, Mexican, Moroccan, pizza, queso and chips, seafood, sushi, tapas, vegetarian, vegan, wings, Tex-Mex, free buffet, 2 for 1 specials, half-priced burgers, 10¢ wings, free appetizer, happy hour buffet, special food promotions, 2 for 1 steak night, buy one get one free day, buy one get one free night, etc. A drink option may be a type of drink, drink special, or other drink-related attribute desired by the user 204. The drink option may include, for example, a type of drink for which the user 204 desires a special offer (e.g. happy hour special) or a drink special offering or recognition. Non-limiting examples of a drink option include domestic bottled beer, imported bottled beer, premium bottled beer, domestic draft beer, imported draft beer, premium draft beer, Bloody Mary, Bellini, bottled cider, draft cider, Cognac, happy hour special, happy hour pricing, Jägermeister, ladies' night, Lemon Drop, Long Island Iced Tea, Margarita, Martini, mixed drink, Sake, Scotch, shot special, tequila, wine, whiskey, well drink, half-priced wine nights, $2 you-call-its, $3 Crown and Coke, $6 buckets of domestic beer, $5 pitchers of beer, “Best margarita in Dallas voted by Dallas Observer magazine”, “Biggest beer in Texas”, “Tastiest martini in Boulder”, special drink promotions, shot specials, beer specials, shot and beer specials, etc.

A special interest may include a particular interest or activity that the user 204 desires in an entertainment venue, including, but not limited to, adult, belly dancers, live bowling, video bowling, bikini contest, cigar Lounge, dancing, dance contests, darts, eating contest, foosball, karaoke contest, topless, open microphone night, live poker, video poker, poolside area, pool/billiards, stripping, swing dancing, live trivia, video trivia, live sports, video sports, volleyball, wet T-shirt contests, mechanical bull riding, smoking, fireplace, valet, etc. A sports option may include a particular sport, sporting event, sport team, sport league, alumni group, or alumni event of interest to the user 204, including, but not limited to, National Football League, National Basketball League, National Hockey League, Major League Baseball, Major League Soccer, NCAA, UFC, boxing, international soccer, college football, a particular college (e.g., University of Texas, University of North Texas, etc.), a particular professional sports team (e.g., Dallas Cowboys, New Orleans Hornets, etc.), a college or other sporting event (e.g., Texas/OU game, BCS Bowl, Super Bowl, etc.), tennis, golf, alumni group (e.g., LSU, UCLA, etc.), alumni event (e.g., Tulane tailgate party, UC-Berkeley Crawfish Boil, etc.) etc. Other types of user-selected entertainment venue attributes may also be available to the user 204.

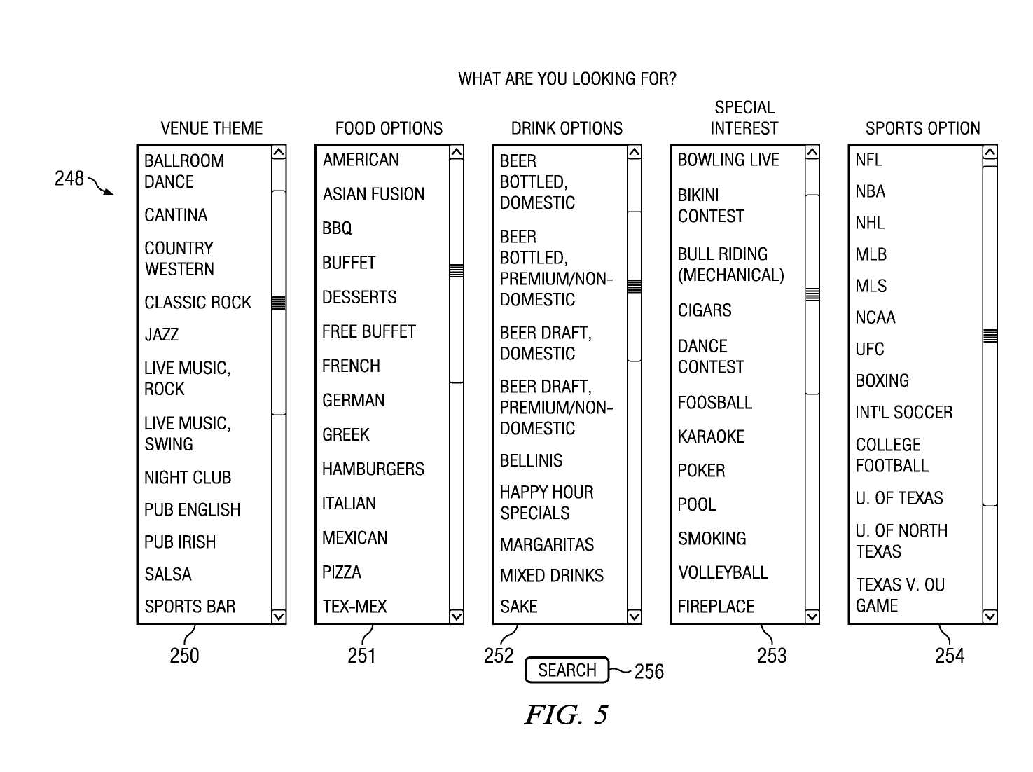

Referring to FIG. 5, in one embodiment, the user interface 234 may initiate an entertainment venue attributes prompt 248 on the graphical user interface 240 of the communication device 212. In the non-limiting example of FIG. 5, the entertainment venue attributes prompt 248 simultaneously presents a. venue theme selection prompt 250, a food option selection prompt 251, a drink option selection prompt 252, a special interest selection prompt 253, and a sports option selection prompt 254. However, in other embodiments, the venue theme selection prompt 250, the food option selection prompt 251, the drink option selection prompt 252, the special interest selection prompt 253, and/or the sports option selection prompt 254, or any combination thereof, may be presented on separate screens on the graphical user interface 240.

Using the venue theme selection prompt 250, the user 204 may select one or more venue themes. Using the food option. selection prompt 251, the user 204 may select one or more food options. Using the drink option selection prompt 252, the user 204 may select one or more drink options. Using the special interest selection prompt 253, the user 204 may select, one or more special interests. Using the sports option selection prompt 254, the user 204 may select one or more sports options.

Multiple selections in each of the selection prompts 250, 251, 252, 253, 254 may be made by the user 204 by, for example, holding down the Ctrl button on the user's keyboard and selecting the multiple options. The user-selected set of entertainment venue attributes used by entertainment venue manager 202 to find a set of customized entertainment venues for the user 204 may be selected using the entertainment venue attributes prompt 248 such that the user-selected set of entertainment venue attributes includes at least one of a venue theme, a food option, a drink option, a special interest, and/or a sports option. Once the user 204 has selected the user-selected set of entertainment venue attributes, the user 204 may select a search button 256 that causes entertainment venue manager 202 to find and identify a customized set of entertainment venues, as described herein. In another embodiment, the user 204 may be prompted to enter other types of data after submitting the user-selected set of entertainment venue attributes (e.g., location, date, time, which options the user deems more important, etc.).

In another embodiment, the entertainment venue attributes prompt 248 may include an additional field that allows the user 204 to manually input, a venue theme, a food option, a drink option, a special interest, a sports option, or any other attribute; such manual entry may allow the user 204 to input or add an entertainment venue attribute that does not appear in the entertainment venue attributes prompt 248, or that does not fit into one of the categories in the entertainment venue attributes prompt 248. In another embodiment, the sports option selection prompt 254 may presented separately from the other selection prompts 250, 251, 252, 253 to facilitate user selection of a wider array of sports options; in this embodiment, the sports options may categorized in various ways, such as by sports league, college, event, alumni, or any other criteria.

In one embodiment, the prompt 236 in which a location is inputted, the prompt 241 in which a date or time is inputted, and the entertainment venue attributes prompt 248 may be presented to the user 204 in a particular sequence. For example, the user interface 234 may first present the prompt 236 for a location of the user 204, followed, by the prompt 241 for the user-selected time and date, and followed by presenting the entertainment venue attributes prompt 248. However, in other embodiments, the prompts 236, 241, and 248 may be presented in any order, or simultaneously in any combination, to the user 204. In other embodiments, only a portion of the prompts 236, 241, and 248 may be presented to the user 204. Other prompts may also be presented to the user 204 to implement the functionality or the entertainment venue manager 202.

In one embodiment, the entertainment venue manager 202 may generate and/or store a user profile 258 for the user 204. The user profile 258 may be stored on the database 226. Indeed, any number of user profiles 258 may be generated and stored by entertainment venue manager 202 for any number of users. The user profiles 258 may store any type of data or attributes of the user 204, including, but not limited to, the name of the user 204, financial information, of the user 204, favorite or preferred locations of the user 204, the user's address or contact information, previously inputted locations, previously inputted times or dates, previously inputted user-selected entertainment venue attributes, etc.

In one embodiment, the user 204 may be allowed to set or an account with the entertainment venue manager 202, and may log in to change his or her user profile 258 or perform a search using the entertainment venue manager 202. In another embodiment, no account may be required by the entertainment venue manager 202, and the user 204 may use the entertainment venue manager 202 as a member of the general public without the need to log on to the entertainment venue manager 202.

In one embodiment, previously inputted or used criteria or data, such as preferred or favorite locations of the user 204 may be accessed from the user profile 258 for use in future entertainment venue searches by the entertainment venue manager 202, thereby helping to prevent the user 204 from having to input the same or similar data multiple types for multiple searches. For example, the data in the user profile 258 may be useful for repeat searches by the user 204 that have frequently-occurring criteria (e.g., location).

In one embodiment, the entertainment venue manager 202 may include an entertainment venue determination engine 260 to compare the location of the user 204, the user-selected time and/or date, and/or the user-selected set of entertainment venue attributes with entertainment venue attributes 228 for the entertainment venues 220 to determine a set of customized entertainment venues for the user 204. In another embodiment, the entertainment venue determination engine 260 may compare the location of the user 204, the user-selected date and/or time, and/or the user-selected set of entertainment venue attributes with the entertainment venue profiles 230 to determine the set of customized entertainment venues for the user 204.

In one embodiment, the entertainment venue determination engine 260 may determine the set of customized entertainment venues to be presented to the user 204 by determining whether one or more keywords in at least one of the location of the user 204, the user-selected date and/or time, and/or the user-selected set of entertainment venue attributes match one or more keywords in the entertainment venue attributes 228 for the entertainment venues 224. By way of non-limiting example, if the location of the user 204 is Dallas, Tex., the user 204 desires to patronize an entertainment venue on Aug. 16, 2011 at 5 pm, and the user 204 is interested in sports bars that have happy hour specials, the entertainment venue determination engine 260 may search the entertainment venue attributes 228 for the keywords “Dallas Texas”, “Aug. 16, 2011”, “sports”, “bar”, “happy hour” to determine which of the entertainment venues 224 matches the user's criteria. Those entertainment venues that match, or partially match, the user's criteria may be added to the set of customized entertainment venues to be presented to the user 204.

All or a portion of the keywords in the location, the user-selected date and/or time, and/or the user-selected set of entertainment venue attributes may be used by the entertainment venue determination engine 260, and, as described below, each of these criteria may be given a particular weight by the user 204. Also, all or a portion of the user-selected set of entertainment venue attributes may be subject to a keyword match by the entertainment venue determination engine 260 with the entertainment venue attributes 228. In another embodiment, the criteria entered by or associated with the user 204 may be parsed, or undergo other text processing, in order to determine keywords for use by the entertainment venue determination engine 260 in subsequent keyword-comparison processing.

In another embodiment, the entertainment venue determination engine 260 may determine the set of customized entertainment venues by determining the set of entertainment venues 224 at or within a predetermined distance from the location of the user 204 in another embodiment, in addition to determining which of entertainment venues 224 are at or within a predetermined distance from the location of the user 204, the entertainment venue determination engine 260 may determine which of the entertainment venues 224 offer at least one of the user-selected set of entertainment venue attributes at least partially during the user-selected date and/or time. In an example in which the user 204 is located at ZIP code 75219, desires to patronize an entertainment venue on Aug. 16, 2012 at 7 o'clock PM, and desires to watch an NFL football game, the entertainment venue determination engine 260 may determine which of the entertainment venues 224 are at or within a predetermined distance (e.g., 1 mile, 5 miles, 50 miles, etc.) from ZIP code 75219, and also determine which of the entertainment venues 224 are playing NFL football games at 7 o'clock PM on Aug. 16, 2012. It will be appreciated that that predetermined. distance may be determined in any manner, including by the user 204 or the entertainment venue manager 202.

The entertainment venue determination engine 260 may also assist the user 204 in finding special offers on the food options or drink options selected. by the user 204. Special offers include sales, happy hours, discounts, bonuses, or any other type of special offer. In embodiment, in determining the of customized entertainment venues, the entertainment venue determination engine 260 may determine which of the entertainment venues 224 have a special offer for the drink option or food option selected by the user 204, such as the drink option or food option selected user 204 in the entertainment venue attributes prompt 248. The entertainment venue determination engine 260 may also determine which of the entertainment venues 224 has a special offer for the drink or food option selected by the user 204 at least partially during the user-selected time and/or date, and/or which located at or within a predetermined distance from the location of the user 204. By way of illustration, it the user 204 selects domestic draft beer as a drink option, the user locator 238 determines that the user 204 is located in Boulder, Colo., and the user 204 selects a date of Dec. 16, 2011 and a time of 8 o'clock PM, the entertainment venue determination engine 260 may determine a set of customized entertainment venues for the user 204 by determining which of the entertainment venues 224 have drink specials for domestic draft beers within a 15-mile radius of Boulder, Colo. at 8 o'clock PM on Dec. 16, 2011. By way of further illustration, if the user selects “half-price pints” as the drink option, the user locator 238 determines that the user 204 is located in ZIP code 75219, and the user-selected. time and date default to a current time and date of Dec. 16, 2011 at 8 o'clock PM, the entertainment venue determination engine 260 may determine a set of customized entertainment venues for the user 204 by determining which of the entertainment venues 224 have half-price pints within a 1-mile radius of ZIP code 75219 at 8 o'clock PM on Dec. 16, 2011.

In another embodiment, the entertainment venue determination engine 260 may determine which of entertainment venues 224 offer at least one of the venue theme, food option, drink option, special interest, or sports options selected by the user 204. In another embodiment, the entertainment venue determination engine 260 may determine the set of customized entertainment venues to be presented to the user 204 by determining that one or more of the user-selected set of entertainment venue attributes (e.g., a venue theme, food option, drink option, special interest, sports option, etc.) matches one or more of the entertainment venue attributes 228 in one or more entertainment venue profiles 230. The entertainment venue determination engine 260 may also determine whether one or more words or keywords in the user's criteria (e.g., the location of the user 204, the user-selected date and/or time, and/or the user-selected set of entertainment venue attributes) matches one or more words or keywords in one or more of the entertainment venue profiles 230, and present these matching entertainment venues to the user 204 as the set of customized entertainment venues.

In another embodiment, the user 204 may input, or the entertainment venue manager 202 may assign, an attribute weight that determines the importance of one or more of the entertainment venue search criteria (e.g., the location of the user 204, the user-selected date and/or time, any one or more of the user-selected set of entertainment venue attributes, etc.). For example, the user 204 may specify that his or her location is the most important criteria when determining the set of customized entertainment venues; in this case, the entertainment venue determination. engine 260 may assign a heavier weight to the location of the entertainment venues 224 than for other criteria (e.g., date and/or time, the user-selected set of entertainment venue attributes, etc.) when determining the set of customized entertainment venues to be presented to the user 204.

In one embodiment, in assigning an attribute weight, the user 204 or the entertainment venue manager 202 may assign each criterion. a mandatory or optional status. If one of the criteria is assigned a mandatory status, the set of customized entertainment venues determined by the entertainment venue determination engine 260 may be required to contain or offer that criteria. For example, if the user 204 specifies that a venue theme of “sports bar” is a mandatory attribute, then the customized entertainment venues presented to the user 204 may all be sports bars. If, on the other hand, a particular criterion is assigned an optional, or preferred, status, it may not be mandatory that the customized entertainment venues identified by the entertainment venue determination engine 260 have that particular criterion. It will he appreciated that attribute weights may, or may not, be used by the entertainment venue determination engine 260, depending upon the embodiment.

In one embodiment, the entertainment venue manager 202 may include an entertainment venue presentation module 262 to present the set of customized entertainment venues to the user 204. The customized entertainment venues, as determined by the entertainment venue determination engine 260, may he presented to the user 204 on the graphical user interface 240 of the communication device 212. The entertainment venue presentation module 262 may sort the customized entertainment venues in any order, including a user-defined order. Non-limiting examples of sorting methodology that may be used by the entertainment venue presentation module 262 includes sorting in order of: entertainment venue relevance to the criteria of the user 204, the number of keywords matched between the user's criteria and entertainment venue attributes 228, the distance to the location of the user 204, alphabetical order, according to an attribute weight, etc. In addition, the relevance of the customized entertainment venues may be displayed by the entertainment venue presentation module 262 by displaying the number of matched words or keywords between the user's criteria and the entertainment venue's profile 230 or attributes. For example, if the user 204 chooses three user-selected entertainment venue attributes from the entertainment venue attribute prompt 248, then the displayed customized entertainment venues may each be displayed next to the number of entertainment venue attributes found for that entertainment venue (e.g., 3 out of 3, 2 out of 3, 1 out of 3, 0 out of 3, etc.); this data may also be displayed as a percentage (e.g., 100%, 66%, 33%, 0%, etc.).

Also, when presenting the set of customized entertainment venues, one or more of the set of customized entertainment venues may include an associated URL, website information, mapping information (Google®, Yahoo®, GPS, etc.); in another embodiment, any of this data may be displayed upon user selection of a particular entertainment venue from the displayed list of matching entertainment venues.

In one embodiment, the user's selection from the set of customized entertainment venues may be communicated or posted to users in a variety of ways, such as via a social network notification (e.g., FourSguare®, Facebook®, Twitter®, LinkedIn®, etc.), text or SMS message, e-mail, voicemail, etc. For example, if the user 204 selects, or otherwise chooses, a particular sport bar (including by clinking on a link for the particular sports bar displayed by the entertainment venue presentation module 262), then the entertainment venue manager 202 may notify other user's using social networking notifications. Such notification methods may be defined by the user 204, the entertainment venue manager 202, or other entity or user.

In another embodiment, the entertainment venue manager 202 may allow the user 204 to set up alerts that notify the user 204 when one or more of the entertainment venues 220 match criteria selected by, or associated with, the user 204 including, but not limited to, the location of the user 204, the user-selected date and/or time, and/or any of the user-selected, set of entertainment venue attributes.

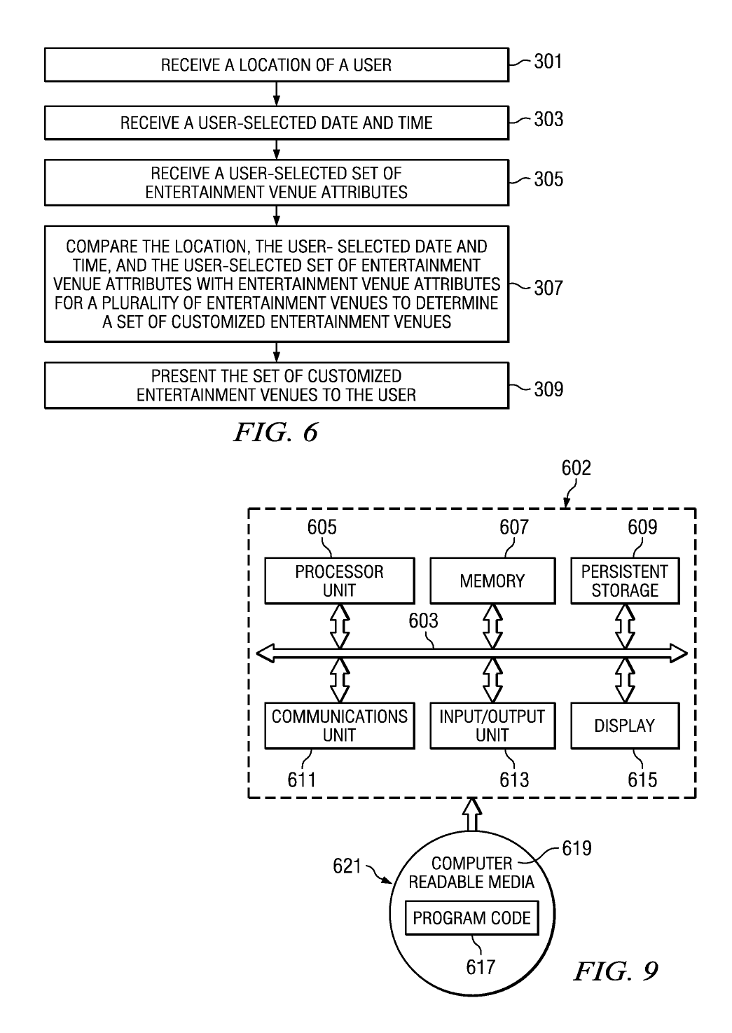

Referring to FIG. 6, an illustrative embodiment of a process for identifying an entertainment venue, which may be implemented by the entertainment venue manager 102 or 202 in FIG. 1 or 2, includes receiving a location of a user (step 301). The process may receive a user-selected date and time (step 303). The process may receive a user-selected set of entertainment venue attributes (step 305). The process may compare the location, the user-selected date and time, and the user-selected set of entertainment venue attributes with entertainment venue attributes for a plurality of entertainment venues to determine a customized entertainment venues (step 307). The process may present the set of customized entertainment venues to the user (step 309).

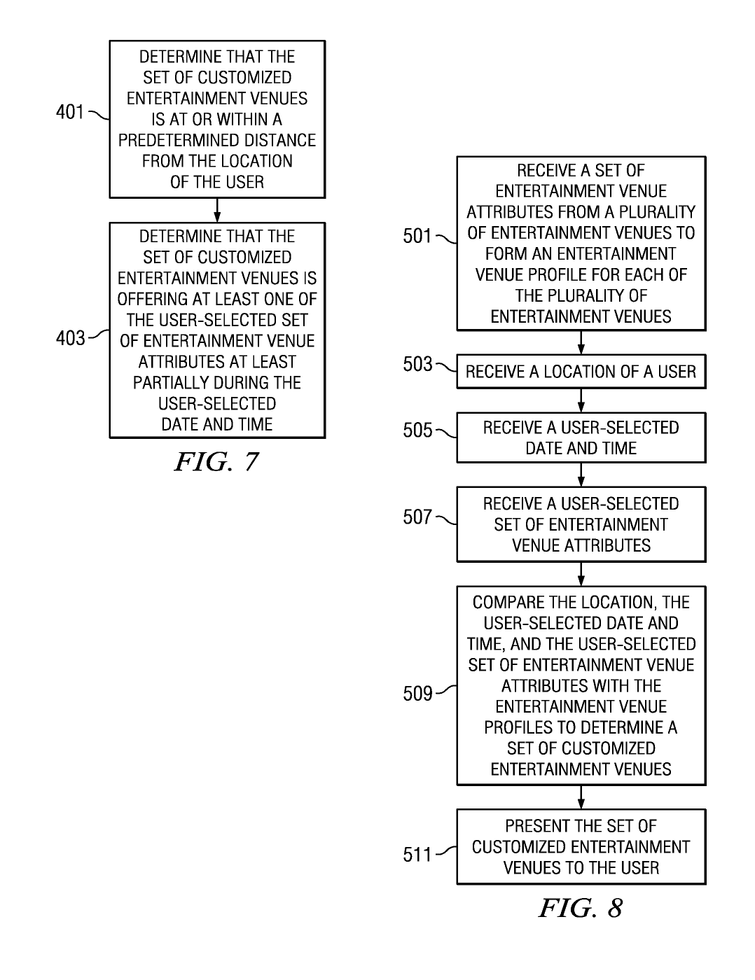

Referring to FIG. 7, an illustrative embodiment of step 307 in FIG. 6 may include determining that the set of customized entertainment venues is at or within a predetermined distance from the location of the user (step 401). Step 307 of FIG. 6 may also include determining that the set of customized entertainment venues is offering at least one of the user-selected set of entertainment venue attributes at least. partially during the user-selected date and time (step 403). As described in the illustrative embodiments described herein, the process described in step 307 of FIG. 6 may be implemented in a variety of ways.

Referring to FIG. 8, an illustrative embodiment of a process for identifying an entertainment venue, which may be implemented by the entertainment venue manager 102 or 202 in FIG. 1 or 2, includes receiving a set of entertainment venue attributes from a plurality of entertainment venues to form an entertainment venue profile for each of the plurality of entertainment venues (step 501). The process may receive the location of a user (step 503). The process may receive a user-selected date and time (step 505). The process may receive a user-selected set of entertainment venue attributes (step 507). The process may compare the location, the user-selected date and time, and the user-selected set of entertainment venue attributes with the entertainment venue profiles to determine a set of customized entertainment venues (step 509). The process may present the set of customized entertainment venues to the user (step 511)

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions tor implementing the specified function or functions. In some alternative implementations, the function or functions noted in the block may occur out of the order noted in Figures. For example, in some cases, two blocks shown in succession may be executed substantially concurrently, or the blocks may sometimes be executed in the reverse order, depending upon the functionality involved.

Referring to FIG. 9, a block diagram of a computing device 602 is shown in which the illustrative embodiments may be implemented. The computing device 602 may one of the communication devices 112 or 212 described in FIG. 1 or 2, or the server 118 in FIG. 1. In another embodiment, the entertainment venue manager 102 or 202 in FIG. 1 or 2 may be implemented on computing device 602. Computer-usable program node or instructions implementing the processes used in the illustrative embodiments may be located on the computing device 602. The computing device 602 includes a communications fabric 603, which provides communications between a processor unit 605, a memory 607, a persistent storage 609, a communications unit 611, an input/output (I/O) unit 613, and a display 615.

The processor unit 605 serves to execute instructions for software that may be loaded into the memory 607. The processor unit 605 may be a set of one or more processors or may be a multi-processor core, depending on the particular implementation. Further, the processor unit 605 may be implemented using one or more heterogeneous processor systems in which a main processor is present with secondary processors on a single chip. As another illustrative example, the processor unit 605 may be a symmetric multi-processor system containing multiple processors of the same type.

The memory 607, in these examples, may be, for example, a random access memory or any other suitable volatile or non-volatile storage device. The persistent storage 609 may take various forms depending on the particular implementation. For example, the persistent storage 609 may contain one or more components or devices. For example, the persistent storage 609 may be a hard drive, a flash memory, a rewritable optical disk, a rewritable magnetic tape, or some combination of the above. The media used by the persistent storage 609 also may be removable. For example, a removable hard drive may be used for the persistent storage 609.

The communications unit 611, in these examples, provides for communications with other data processing systems or communication devices. In these examples, communications unit 611 may be a network interface card. The-communications unit 611 may provide communications through the use of either or both physical and wireless communication links.

The input/output unit 613 allows for the input and output of data with other devices that may be connected to the computing device 602. For example, the input/output unit 613 may provide a connection for user input through a keyboard and mouse. Further, the input/output unit 613 may send output to a processing device. In the case in which the computing device 602 is a cellular phone, the input/output unit 613 may also allow devices to be connected to the cellular phone, such as microphones, headsets, and controllers. The display 615 provides a mechanism to display information to a user, such as a graphical user interface.

Instructions for the operating system and applications or programs are located on the persistent storage 609. These instructions may be loaded into the memory 607 for execution by the processor unit 605. The processes of the different embodiments may be performed by the processor unit 605 using computer-implemented instructions, which may be located in a memory, such as the memory 607. These instructions are referred to as program code, computer-usable program code, or computer-readable program code that may be read and executed by a processor in the processor unit 605. The program code in the different embodiments may be embodied on different physical or tangible computer-readable media, such as the memory 607 or the persistent storage 609.

Program code 617 is located in a functional form on a computer-readable storage media 619 and may be loaded onto or transferred to the computing device 602 for execution by the processor unit 605. The program code 617 and the computer-readable media 619 form computer program product 621 in these examples in one embodiment, the computer program product 621 is the entertainment venue manager 102 or 202 in FIG. 1 or 2, respectively. In this embodiment, the program code 617 may include computer-usable program code capable of receiving a location of a user, receiving a user-selected date and time, and receiving a user-selected set of entertainment venue attributes. The program code 617 may also include computer-usable program code capable of comparing the location, the user-selected date and time, and the user-selected set of entertainment venue attributes with entertainment venue attributes for a plurality of entertainment venues to determine a set of customized entertainment venues. The program code 617 may also include computer-usable program code capable of presenting the set of customized entertainment venues to the user.

In another embodiment, the program code 617 may include computer-usable program code capable of receiving a set of entertainment venue attributes from a plurality of entertainment venues to form an entertainment venue profile for each of the plurality of entertainment venues. The program code 617 may also include computer-usable program code capable of receiving a location of a user, receiving a user-selected date and time, and receiving a user-selected set of entertainment venue attributes. The program code 617 may also include computer-usable program code capable of comparing the location, the user-selected date and time, and the user-selected set of entertainment venue attributes with the entertainment venue profiles to determine a set of customized entertainment venues. The program code 617 may also include computer-usable program code capable or presenting the set of customized entertainment venues to the user. Any combination of the above-mentioned computer-usable program code may be implemented in the program code 617, and any functions of the illustrative embodiments may be implemented in the program code 617.

In one example, the computer-readable media 619 may be in a tangible form, such as, for example, an optical or magnetic disc that is inserted or placed into a drive or other device that is part of the persistent storage 609 for transfer onto a storage device, such as a hard drive that is part of the persistent storage 609. In a tangible form, the computer-readable media 619 also may take the form of persistent storage, such as a hard drive or a flash memory that is connected to computing device 602. The tangible form of the computer-readable media 619 is also referred to as computer recordable storage media.

Alternatively, the program code 617 may be transferred to the computing device 602 from the computer-readable media 619 through a communication link to the communications unit 611 or through a connection to the input/output unit 613. The communication link or the connection may be physical or wireless in the illustrative examples. The computer-readable media 619 also may take the form of non-tangible media, such as communication links or wireless transmissions containing the program code 617. In one embodiment, the program code 617 is delivered to the computing device 602 over the Internet.

The different components illustrated for the computing device 602 are not meant to provide architectural limitations to the manner in which different embodiments may be implemented. The different illustrative embodiments may be implemented in a data processing system including components in addition to or in place of those illustrated for computing device 602. Other components shown in FIG. 9 can be varied from the illustrative examples shown.

As one example, a storage device in the computing device 602 is any hardware apparatus that may store data. The memory 607, the persistent storage 609, and the computer-readable media 619 are examples of storage devices in a tangible form.

In another example, a bus system may be used to implement the communications fabric 603 and may be comprised of one or more buses, such as a system bus or an input/output bus. Of course, the bus system may be implemented using any suitable type of architecture that provides for a transfer of data between different components or devices attached to the bus system. Additionally, the communications unit 611 may include one or more devices used to transmit and receive data, such as a modem or a network adapter. Further, a memory may be, for example, the memory 607 or a cache such as found in an interface and memory controller hub that may be present in the communications fabric 603.

As used herein, including in the claims, the terms first, second, third, etc . . . used In relation to an element (e.g., first entertainment venue, second entertainment venue, etc.) are for reference or identification purposes only, and these terms, unless otherwise indicated, are not intended. to describe or suggest a number, order, source, purpose, or substantive quality for any element for which such a term is used.

Although the illustrative embodiments described herein have been disclosed in context of certain illustrative, non-limiting embodiments, it should be understood that various changes, substitutions, permutations, and alterations can be made without departing from the scope of the invention as defined by the appended claims. It sill be appreciated that any feature that is described in a connection to any one embodiment may also be applicable to any other embodiment.

What is claimed is:

1. A method for identifying an entertainment venue, the method comprising:
receiving a location of a user;
receiving a user-selected date and time;
receiving a user-selected set of entertainment venue attributes;
comparing, using a processor, the location, the user-selected date and time, and the user-selected set of entertainment venue attributes with entertainment venue attributes for a plurality of entertainment venues to determine a set of customized entertainment venues; and
presenting the set of customized entertainment venues to the user.

2. The method of claim 1, wherein receiving the location of the user comprises:
prompting the user to enter a postal code associated the location of the user; and
receiving the postal code inputted by the user to determine the location of the user.

3. The method of claim 1, wherein the user is associated with a communication device, and wherein receiving the location of the use comprises determining the location of the user using an internet protocol address of the communication device.

4. The method of claim 1, wherein the user is associated with communication device having a graphical user interface, and wherein receiving the user-selected set of entertainment venue attributes comprises:
presenting a venue theme selection prompt on the graphical user interface of the communication device, a venue theme selectable by the user using the venue theme selection prompt;
presenting a food option selection prompt on graphical user interface of the communication device, a food. option selectable by the user using the food option selection, prompt;
presenting a drink option selection prompt on the graphical user interface of the communication device, a drink option selectable by the user using the drink option selection prompt;
presenting a special interest selection prompt on the graphical user interface of the communication device, a special interest selectable by the user using the special interest selection prompt; and
presenting a sports option selection prompt on the graphical user interface of the communication device, a sports option selectable by the user using the sports option selection prompt;
wherein the user-selected set of entertainment venue attributes comprises at least one of the venue theme, the food option, the drink option, the special interest, or the sports option selected by using at least one of the venue theme selection prompt, the food option selection prompt, the drink option selection prompt, the special interest selection prompt, or the sports option selection prompt, respectively.

5. The method of claim 4, wherein the venue theme selection prompt, the food option selection prompt, the drink option selection prompt, the special interest selection prompt, and the sports option selection prompt are simultaneously presented on the graphical user interface of the communication device.

6. The method of claim 4, wherein a plurality of venue themes are selectable by the user using the venue theme selection prompt;
wherein a plurality of food options are selectable by the user using the food option selection prompt;
wherein a plurality of drink options are selectable by the user using the drink option selection prompt;
wherein a plurality of special interests are selectable by the user using the special interest selection prompt; and
wherein a plurality of sports options are selectable by the user using the sports option selection prompt.

7. The method of claim 1, wherein receiving the location of the user is in response to prompting the user to input the location of the user;
wherein receiving the user-selected date and time is in response to prompting the user to input the user-selected date and time; and
wherein receiving the user-selected set of entertainment venue attributes is in response to prompting the user to input the user-selected set of entertainment venue attributes.

8. The method of claim 1, further comprising:
generating and storing an entertainment venue profile for each of the plurality of entertainment venues, wherein generating and storing the entertainment venue profile for each of the plurality of entertainment venues comprises:
receiving one or more entertainment venue attributes from a first entertainment venue in the plurality of entertainment venues; and
generating a first entertainment venue profile for the first entertainment venue, the first entertainment venue profile comprising the one or more entertainment venue attributes received from the first entertainment venue.

9. The method of claim 1, wherein comparing the location, the user-selected date and time, and the user-selected set of entertainment venue attributes with entertainment venue attributes for the plurality of entertainment venues to determine the set of customized entertainment venues comprises determining whether one or more keywords of at least one of the location, the user-selected date and time, or the user-selected set of entertainment venue attributes match one or more keywords of the entertainment venue attributes for the plurality of entertainment venues.

10. The method of claim 1, wherein comparing the location, the user-selected date and time, and the user-selected set of entertainment venue attributes with entertainment venue attributes for the plurality of entertainment venues to determine the set of customized entertainment venues comprises determining that the set of customized entertainment venues is at or within a predetermined distance from the location of the user.

11. The method of claim 1, wherein the user-selected set of entertainment venue attributes comprises a drink option, and wherein comparing the location, the user-selected date and time, and the user-selected set of entertainment venue attributes with entertainment venue attributes for the plurality of entertainment venues to determine the set of customized entertainment venues comprises determining that the set of customized entertainment venues has a special offer for the drink option selected by the user.

12. The method of claim 11, wherein determining that the set of customized entertainment venues has the special offer for the drink option selected by the user comprises:
determining that the set of customized entertainment venues has the special offer for the drink option selected by the user at least partially during the user-selected date and time; and
determining that the set of customized entertainment venues is at or within a predetermined distance from the location of the user.

13. The method of claim 1, wherein comparing the location, the user-selected date and time, and the user-selected set of entertainment venue attributes with entertainment venue attributes for the plurality of entertainment venues to determine the set of customized entertainment venues comprises:
determining that the set of customized entertainment venues is at or within a predetermined distance from the location of the user; and
determining that the set of customized entertainment venues is offering at least one of the user-selected set of entertainment venue attributes at least partially during the user-selected date and time.

14. The method of claim 1, wherein the user-selected set of entertainment venue attributes comprises at least one of a venue theme, a food option, a drink option, a special interest, or a sports option, and wherein comparing the location, the user-selected date and time, and the user-selected set of entertainment venue attributes with entertainment venue attributes for the plurality of entertainment venues to determine the set of customized entertainment venues comprises determining that the set of customized entertainment venues offers the at least one of the venue theme, the food option, the drink option, the special interest, or the sports option.

15. The method of claim 1, further comprising:
receiving an attribute weight from the user, the attribute weight indicating a user-defined importance of one or more of the user-selected set of entertainment venue attributes;
wherein comparing the location, the user-selected date and time, and the user-selected set of entertainment venue attributes with entertainment venue attributes for the plurality of entertainment venues to determine the set of customized entertainment venues comprising comparing the location, the user-selected date and time, and the user-selected set of entertainment venue attributes with entertainment venue attributes for the plurality of entertainment venues using the attribute weight to determine the set of customized entertainment venues.

16. A method for identifying an entertainment venue, the method comprising:
receiving a set of entertainment venue attributes from a plurality of entertainment venues to form an entertainment venue profile for each of the plurality of entertainment venues;
receiving a location of a user;
receiving a user-selected date and time;
receiving a user-selected set of entertainment venue attributes;
comparing, using a processor, the location, the user-selected date and time, and the user-selected set of entertainment venue attributes with the entertainment venue profiles to determine a set of customized entertainment venues; and
presenting the set of customized entertainment venues to the user.

17. The method of claim 16, wherein comparing the location, the user-selected date and time, and the user-selected set of entertainment venue attributes with the entertainment venue profiles to determine the set of customized entertainment venues comprises determining that one or more of the user-selected set of entertainment venue attributes matches one or more of the entertainment venue attributes in one or more entertainment venue profiles for the set of customized entertainment venues.

18. An entertainment venue manager comprising:
a user interface to receive a location of a user, a user-selected date and time, and a user-selected set of entertainment venue attributes;
an entertainment venue determination engine to compare the location, the user-selected date and time, and the user-selected set of entertainment venue attributes with entertainment venue attributes for a plurality of entertainment venues to determine a set of customized entertainment venues; and
an entertainment venue presentation module to present the set of customized entertainment venues to the user.

19. The entertainment venue manager of claim 18, wherein the user is associated with a communication device, and wherein the user interface further comprises:
a user locator to receive the location of the user by locating the communication device associated with the user.

20. The entertainment venue manager of claim 18, further comprising:
an entertainment venue interface to receive the entertainment venue attributes from the plurality of entertainment venues to form a plurality of entertainment venue profiles, each of the plurality of entertainment venue profiles corresponding no one of the plurality of entertainment venues.
